(19) United States
(12) Patent Application Publication
(10) Pub. No.: US 2024/0149696 A1
(43) Pub. Date: May 9, 2024

(54) MULTILAYER BRAKING RESISTANCE DEVICE FOR A VEHICLE

(71) Applicant: Siemens Mobility GmbH, München (DE)

(72) Inventors: Peter Dornberger, Nürnberg (DE); Johannes Blisse, Spardorf (DE); Arnd Rüter, Krefeld (DE); Jürgen Quindt, Röthenbach an der Pegnitz (DE); Thorsten Stützle, Erlangen (DE)

(21) Appl. No.: 18/549,012

(22) PCT Filed: Feb. 4, 2022
(86) PCT No.: PCT/EP2022/052676

§ 371 Date: Sep. 5, 2023

(30) Foreign Application Priority Data
Mar. 4, 2021 (DE) 10 2021 202 091.7

(51) Int. Cl. B60L 7/02

(52) U.S. Cl. CPC B60L 7/02; B60L 2200/26

(57) ABSTRACT

A braking resistance device for a vehicle has a plurality of braking resistance elements each having a tubular heat-conducting casing. A heat-conducting and electrically insulating material is disposed in the casing. An electrical conductor is embedded in the insulating material over a majority of the longitudinal extent of the casing. Furthermore, the braking resistance device has a stacking arrangement which is designed to be passively cooled. The stacking arrangement has a plurality of layers which are arranged one above the other in a stacking direction and each including the braking resistance elements of the plurality of braking resistance elements which are arranged substantially parallel to one another.

The invention relates to a braking resistance apparatus for a vehicle, a vehicle having such a braking resistance apparatus and a method for operating the braking resistance apparatus.

Brake resistors are used in vehicles to convert an electrical energy which is recovered in a braking operation of the vehicle into thermal energy. A maximum brake power is accordingly limited by the brake resistors. In this instance, it is necessary to discharge the thermal energy which is produced in a braking operation from the brake resistors. Discharge of this thermal energy can be carried out both in an active and a passive manner. In the case of an active cooling of the brake resistors, other components, such as, for example, a fan or other heat exchangers, which lead to a reduction of the energy efficiency of a braking system having brake resistors are required. Therefore, brake resistors which are passively cooled, that is to say, for example, cooled by a travel wind, are preferred. Document WO 2020/083620 A1 discloses a braking resistance apparatus which is cooled by means of a travel wind. This braking resistance apparatus has a plurality of braking resistance elements which are arranged parallel with each other in a plane. This single-layer arrangement of the braking resistance elements is characterized by a small structural height. In the case of the single-layer arrangement of the braking resistance elements, however, a brake power of the braking resistance elements is linearly proportional to a base face required for the arrangement of the braking resistance elements. This results in a large base face requirement of the braking resistance elements for the provision of a large brake power.

An object of the invention is to provide a compact and energy-efficient braking resistance apparatus.

This object is achieved with a braking resistance apparatus having the features of claim 1.

An object of the invention is to further provide a method for operating the braking resistance apparatus.

This object is achieved with a method having the features of the independent method claim.

Advantageous further developments of the present invention can be derived in each case from the dependent subordinate claims.

The braking resistance apparatus according to the invention for a vehicle has a plurality of braking resistance elements. This plurality of braking resistance elements have in each case a tubular, thermally conductive cover. In the cover mentioned, a thermally conductive and electrically insulating material is arranged. An electrical conductor is embedded in the thermally conductive and electrically insulating material over a large portion of a longitudinal extent of the cover. In this instance, the plurality of braking resistance elements are arranged in a stack arrangement having a plurality of layers. This plurality of layers are in each case formed from braking resistance elements which are arranged substantially parallel with each other. Furthermore, the stack arrangement described is configured to be passively cooled.

The term “over a large portion of a longitudinal extent of the cover” is intended in the present context to be understood to be a distance of at least 50% of an entire longitudinal extent of the cover in a longitudinal extent direction of an associated braking resistance element.

The term “passive cooling” is intended to be understood to be a discharge of a brake energy which has been converted by braking resistance elements from electrical energy into thermal energy by means of an airstream, a convection, a thermal radiation and/or by means of meteorology-related air movement. The stack direction of the stack arrangement may be transverse or preferably substantially perpendicular to a longitudinal extent direction of the braking resistance elements of the stack arrangement.

By means of a thermal capacity of the thermally conductive, electrically insulating material, the thermal energy which occurs briefly during a braking operation can be passively discharged in a continuous manner during travel operation. The most rapid possible discharge of the quantity of heat produced during a braking operation, as previously carried out either by means of a braking resistance element with the largest possible outer faces or an active discharge of the quantity of heat, can be dispensed with. This enables a surface of the cover of the braking resistance element to be kept small. As a result of the stack arrangement, a relationship between a brake power of the braking resistance apparatus and a base face which is covered by the braking resistance elements of the braking resistance apparatus can be significantly increased.

An advantageous further development makes provision for the braking resistance elements of the stack arrangement to be arranged to be spaced apart from each other in such a manner that a travel wind can flow through the stack arrangement. In this instance, the travel wind can flow from an uppermost layer of the stack arrangement to a lowest layer of the stack arrangement. A travel wind can thereby reliably flow around and cool the plurality of layers of the braking resistance elements.

Preferably, a provided flow direction of the airstream through the stack arrangement is substantially parallel with a longitudinal extent direction of the braking resistance elements, particularly when viewed in a plane perpendicular to the stack direction of the stack arrangement.

In another advantageous further development, there is provision for the plurality of layers to be formed in each case from braking resistance elements which are arranged substantially parallel with each other in a plane which extends substantially perpendicularly to the stack direction. This enables an efficient use of structural space available. The braking resistance elements of different layers of the plurality of layers may in this instance be arranged in alignment and/or offset relative to each other in a stack direction.

In an advantageous embodiment of the above-mentioned further development, a clear spacing between braking resistance elements, which are arranged directly adjacent, of a first layer of the multiple layers is at least twice as large, preferably at least three times as large as a clear spacing between the braking resistance elements of the first layer and the braking resistance elements of another layer of the plurality of layers which is arranged directly adjacent to the first layer. In this manner, a flow resistance of the braking resistance apparatus can be reduced. An energy efficiency of the braking resistance apparatus can consequently be increased. The above-mentioned first layer of the plurality of layers may be any layer of the plurality of layers and is not limited to an uppermost layer and/or a lowest layer of the plurality of layers.

In another advantageous embodiment of the above-mentioned further development, there is provision for the clear spacing between directly adjacent braking resistance elements of a layer of the plurality of layers to have at least 1.5 times the value of a greatest extent of one of the braking resistance elements which are arranged directly adjacent. The mentioned greatest extent of the braking resistance elements is measured in a plane substantially perpendicular to the longitudinal extent direction of the braking resistance element. With the above-mentioned clear spacing, in practice, a stack arrangement which can be flowed through with little resistance could be produced.

In an advantageous construction variant of the above-mentioned embodiment, another clear spacing between at least a portion of the braking resistance elements of a first layer of the plurality of layers and braking resistance elements, which are arranged directly adjacent to these braking resistance elements, of another layer which is arranged directly adjacent to the first layer has at least 0.5 times the value of the above-mentioned greatest extent of a braking resistance element which is arranged directly adjacent. In this manner, in practice a compact stack arrangement which can be flowed through with little resistance could be produced.

An advantageous further development makes provision for the braking resistance elements of the stack arrangement to be spaced apart from each other by means of floating bearings which have impact faces which are formed in the manner of flow lines. Impact faces are intended to be understood to be faces of the floating bearing which have a surface normal having a direction component which is directed counter to an intended flow direction of the airstream. A spacing between adjacent braking resistance elements can thus be produced in a simple manner with little flow resistance.

In an advantageous embodiment, the floating bearings have rounded or chamfered impact faces. A production of flow-optimized floating bearings with little complexity is thereby possible.

In another advantageous further development, it is proposed that there be provided at least one fluid-guiding element by means of which an airstream due to a movement of the vehicle can be directed into the stack arrangement in order to cool the braking resistance elements which are arranged in multiple layers. Using the at least one fluid-guiding element, an introduction and/or discharge of the airstream flow into/out of the stack arrangement in order to cool the braking resistance elements can be produced with little flow resistance. An airstream can thereby be directed in a flow-optimized manner between the multiple layers of the braking resistance elements of the stack arrangement.

In an advantageous embodiment of the above-mentioned further development, the at least one fluid-guiding element is at least partially in the form of a ramp. This enables a low-complexity production of a fluid-guiding element. It is further proposed that the ramp be at least partially in the form of an oblique plane. This oblique plane is inclined through an angle from a value range from 10° to 25°, preferably from a value range from 19° to 23° and in a particularly preferred manner of substantially 21° with respect to the longitudinal extent direction of the braking resistance elements of the stack arrangement. In this manner, in practice, a particularly energy-efficient introduction and/or discharge of the airstream could already be produced.

In an alternative construction variant, it is conceivable for the oblique plane to be inclined through an angle from a value range from 100 to 170 with respect to the longitudinal extent direction of the braking resistance elements of the stack arrangement.

In another advantageous construction variant of the ramp, a face of the ramp can be provided with an extent according to a harmonic function in the mathematic sense. In a particularly preferred manner, the ramp has round portions in the transition regions thereof. In this manner, fluid-guiding properties of the at least one fluid-guiding element can be optimized in a simple manner.

In another advantageous construction variant, there is provision for the braking resistance elements of the stack arrangement to extend through the at least one fluid-guiding element in each case. This enables an arrangement of the braking resistance elements in an efficient manner in terms of structural space in combination with a reduction of the flow resistance of the braking resistance apparatus. For example, significant flow resistances, such as impact faces of the braking resistance elements with a large flow resistance, may be arranged outside an airstream. Preferably, in this instance, the at least one fluid-guiding element is arranged in a longitudinal end region of the braking resistance apparatus. A required coverage of the braking resistance elements by the at least one fluid-guiding element can be minimized.

In another advantageous embodiment of the braking resistance apparatus, it is proposed that dissipation paths of the braking resistance elements of the stack arrangement be arranged in a space which is delimited at one side. This space which is delimited at one side is delimited by a side, which is subjected to a flow of travel wind, of the at least one fluid-guiding element. A dissipation path is intended to be understood to be at least one path portion of a braking resistance element, in the longitudinal extent direction thereof, which has an increased dissipation relative to an electrical supply line of the braking resistance element. Generally, along the dissipation path, the electrical conductor is embedded in the thermally conductive, electrically insulating material. This electrical conductor has, compared with an electrical supply line to the braking resistance element, a reduced electrical conductivity. Along the dissipation path, an electrical energy can be converted into a thermal energy in the most efficient manner possible. By means of the above-mentioned arrangement, a cooling of the dissipation paths along an entire extent thereof can be achieved in a simple manner. At least one dissipation path extends in each case in the longitudinal extent direction of the braking resistance elements. Preferably, the dissipation path is constructed in a coherent manner. In a particularly preferred manner, the dissipation path of one of the braking resistance elements has a coherent overall length from a value range of from 2 m to 10 m. In practice, a long coherent dissipation path has been found to be advantageous in comparison with a plurality of shorter dissipation paths.

In another advantageous construction variant of the above-mentioned further development, there is provision for at least one partition wall to be arranged between a rear side of the fluid-guiding element, which faces away from a front side of the fluid-guiding element, which is provided for fluid guiding, and an electrical connection region of the braking resistance elements. An electrical connection region of the braking resistance elements can be thermally shielded by means of the at least one partition wall. In other words, starting from an electrical connection region of the braking resistance elements of the stack arrangement, at least one partition wall is arranged in front of the at least one fluid-guiding element. In this manner, electrical connections of the braking resistance elements can be protected in a simple manner from thermal energy, in particular from an accumulation of heat. A penetration of a heated airstream into the electrical connection region of the braking resistance elements can thus be prevented.

In an advantageous further development, it is proposed that the dissipation paths of the braking resistance elements of a first layer of the plurality of layers and the dissipation paths of the braking resistance elements of another layer of the plurality of layers are constructed with different lengths. By the dissipation paths being adapted to an extent of the at least one fluid-guiding element and/or an intended extent of the movement airstream, a brake power can be optimized.

In another advantageous further development, there is provision for a resistance of the electrical conductors embedded in the braking resistance elements of a first of the plurality of layers and a resistance of the electrical conductors embedded in the braking resistance elements of another of the plurality of layers to be of different sizes. As a result of differently sized resistances, a correspondingly differently sized conversion of an electrical energy into a thermal energy can be produced. This enables larger quantities of energy to be converted in regions inside the stack arrangement in which there is a greater potential for discharging this thermal energy using the airstream. Temperature differences within the stack arrangement can thereby be reduced. Preferably, in the braking resistance elements of the uppermost layer of the plurality of layers, there are embedded electrical conductors by means of which, in comparison with the electrical conductors which are embedded in the braking resistance elements of the remaining layers of the plurality of layers, a larger quantity of electrical energy can be converted into a thermal energy. In comparison with the remaining layers of the plurality of layers, a larger quantity of thermal energy can thus be produced in the uppermost layer during a braking operation. The better heat discharge of the uppermost layer in comparison with the remaining layers can thereby be used to enable an improved temperature distribution inside the stack arrangement. Furthermore, in this manner a ratio of a power of the braking resistance apparatus and a surface, which is required to discharge the converted thermal energy, of the braking resistance elements can be optimized. In addition, an efficiency of the braking resistance apparatus can thereby be improved.

In another advantageous further development, there is provision for the stack arrangement to be arranged in a housing, in particular in a vessel-like housing. The housing has in this instance on one side an opening which extends over at least 80% of a length of one of the dissipation paths of the braking resistance elements of the stack arrangement, preferably over an entire length of a longest dissipation path of the dissipation paths of the braking resistance elements of the stack arrangement. In this manner, a guiding of the airstream through the stack arrangement with low flow resistance can be achieved.

In an advantageous construction variant of the further development, a maximum stack height of the stack arrangement is less than or equal to a maximum housing height of the housing. A flow resistance of the braking resistance apparatus can thus be further reduced.

In another advantageous construction variant of the further development, the housing is delimited at least at two sides of a fluid-guiding element in each case. This enables an introduction and discharge of the airstream with low flow resistance through the plurality of layers of the stack arrangement using the fluid-guiding elements. A cooling of the braking resistance apparatus can in this manner be achieved independently of a travel direction.

Preferably, the stack arrangement is arranged in the housing in such a manner that each of the braking resistance elements of the stack arrangement extends through the housing in the longitudinal extent direction of the braking resistance elements in each case at two positions. This enables flow resistances which are present at both sides on braking resistance elements, such as the above-mentioned impact faces, to be arranged outside the airstream. Furthermore, there are preferably provided at least two partition walls which are arranged outside the housing in each case in one of the two longitudinal end regions of the braking resistance elements of the stack arrangement. A thermal shielding of the electrical connection regions of the braking resistance elements can thus be produced independently of a flow direction of the airstream.

In another additional advantageous embodiment of the above-mentioned further development, the dissipation paths of the braking resistance elements of the stack arrangement are arranged exclusively inside the housing. This enables a cooling of the dissipation paths along the entire length thereof by means of the airstream.

Preferably, the dissipation paths of the braking resistance elements of the plurality of layers of the stack arrangement with different lengths are at least partially adapted to a maximum length extent of the housing. This enables an optimization of the brake power.

In an advantageous embodiment, the braking resistance elements of the stack arrangement are arranged relative to the housing in such a manner that, in a direction substantially perpendicular to the longitudinal extent direction of the braking resistance elements, they are spaced apart to the greatest extent with a clear dimension of at least 1.5 times the greatest extent of the relevant braking resistance elements. In this manner, an airstream may also cool braking resistance elements which are arranged in edge regions, in particular the dissipation paths thereof. An accumulation of heat in edge regions can thus be avoided.

Advantageously, a vehicle is provided with the braking resistance apparatus according to the invention. The vehicle has a vehicle shell. In the vehicle shell, a recess is formed. The braking resistance apparatus is in this instance arranged in a state recessed in the recess of the vehicle shell in such a manner that an uppermost layer of the plurality of layers of the stack arrangement of the braking resistance apparatus is arranged level with or below the vehicle shell which surrounds the recess. The at least one fluid-guiding element may at least partially overlap a surrounding vehicle shell. In this manner, a vehicle with a compact braking resistance apparatus can be provided. In particular, a deterioration of an overall flow resistance of the vehicle can thus be prevented.

In an advantageous further development of the vehicle, the braking resistance apparatus is arranged on a roof of the vehicle in a state recessed in the vehicle shell. This enables an operationally reliable arrangement of the braking resistance apparatus.

Using the method according to the invention, the braking resistance apparatus according to the invention or the vehicle having such a braking resistance apparatus can be operated.

The method according to the invention makes provision for the braking resistance elements which are arranged one above the other in multiple layers in a stack arrangement to be passively cooled by an airstream. This enables an energy-efficient cooling of the braking resistance apparatus, in which additional energy expenditures for cooling the braking resistance apparatus, for example, by means of active cooling apparatuses, can be prevented.

The above-described properties, features and advantages of the invention and the manner in which they are achieved are explained in greater detail in connection with the FIGS. in the following description of one exemplary embodiment of the invention. Where appropriate, the same reference numerals are used in the Figures for the same or mutually corresponding elements of the invention. The exemplary embodiment serves to explain the invention and does not limit the invention to the combinations of features set out therein or with respect to functional features. In addition, all the features set out can be considered in isolation and combined in an appropriate manner with the features of any claim.

In the Drawings:

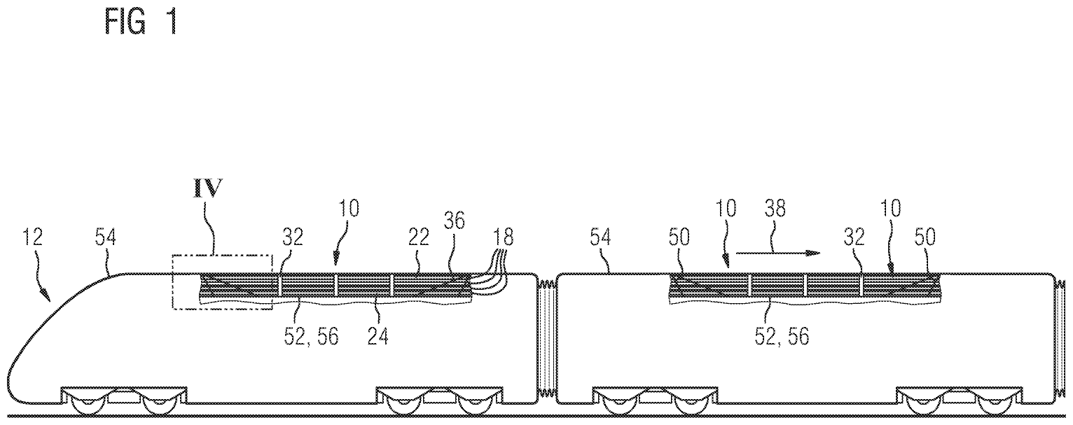

FIG. 1 shows a schematic illustration of a vehicle with an example of the braking resistance apparatus according to the invention and an illustration of an example of the operation according to the invention of the braking resistance apparatus;

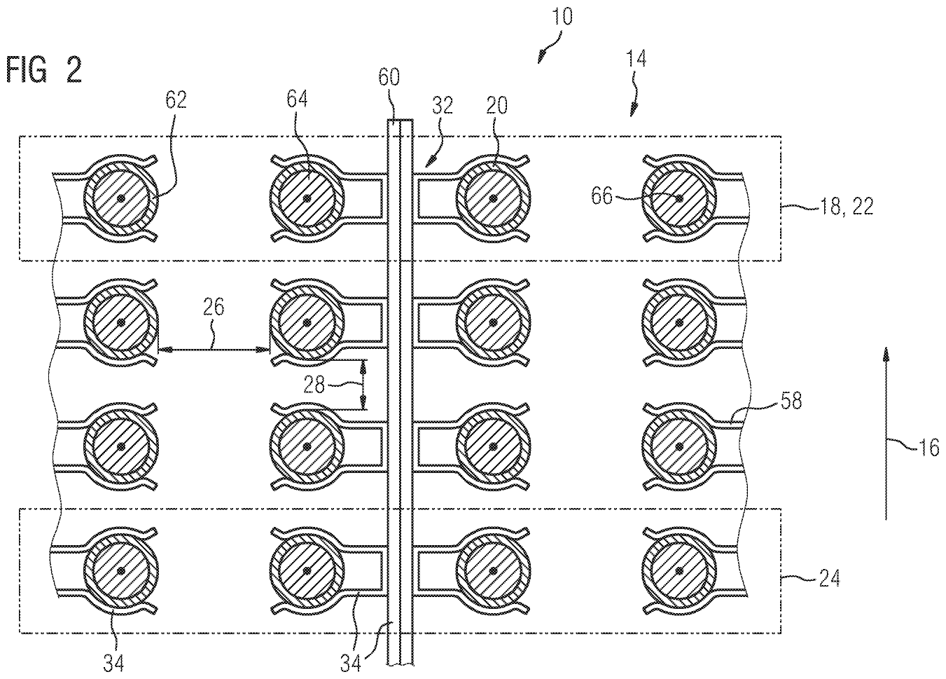

FIG. 2 shows a schematic illustration of a cross section in a plane perpendicular to a longitudinal extent direction of the braking resistance elements of the exemplary embodiment of the braking resistance apparatus;

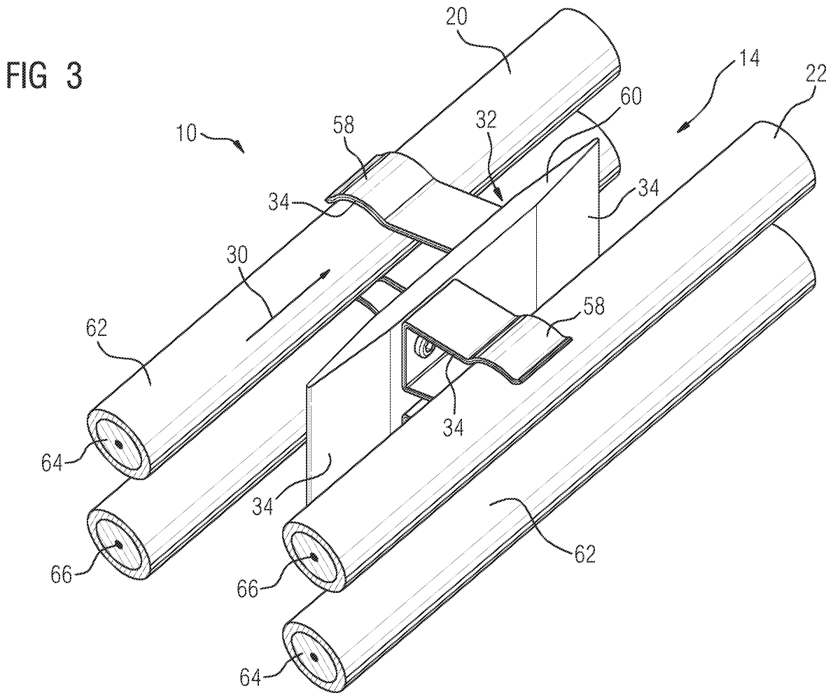

FIG. 3 shows a detailed view of a floating bearing of the exemplary embodiment of the braking resistance apparatus in a schematic illustration;

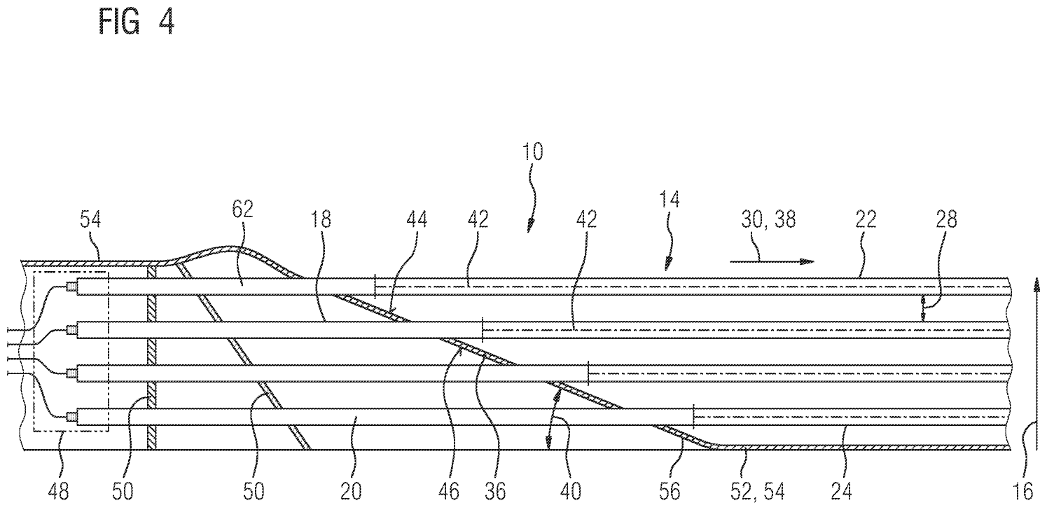

FIG. 4 shows an end region of the exemplary embodiment of the braking resistance apparatus as a schematic illustration.

FIG. 1 shows a schematic illustration of an exemplary embodiment of the braking resistance apparatus 10 according to the invention in a vehicle 12. Furthermore, FIG. 1 illustrates a method according to the invention for operating the braking resistance apparatus 10.

The vehicle 12 is in the form of a track-bound, multi-unit vehicle and has a vehicle shell 4. A recess 56 is provided in the vehicle shell 54. The recess 56 is arranged on the roof of the vehicle 12 in the vehicle shell 54. The braking resistance apparatus 10 is arranged in a state recessed in this recess 56. This braking resistance apparatus 10 is passively cooled by means of an airstream 38.

The braking resistance apparatus 10 has a stack arrangement 14 having four layers 18 of braking resistance elements 20 which are arranged one above the other in a stack direction 16. Each of the four layers 18 is formed from a plurality of braking resistance elements 20 which are arranged substantially parallel with each other in a plane. Each of the four planes in which the braking resistance elements 20 are arranged extends substantially perpendicularly to the stack direction 14.

In FIG. 2, a cross section through the stack arrangement 14 is illustrated in a plane which extends substantially perpendicularly to a longitudinal extent direction 30 of the braking resistance elements 20.

In the present exemplary embodiment, a structure of the braking resistance elements 20 corresponds in each case to an already known tubular heating member. In this instance, each of the braking resistance elements 20 has a tubular cover 62 having a round cross section. In the same manner, a polygonal cross section of the cover is also conceivable as an alternative. The cover 62 comprises a high-temperature-resistant metal or a high-temperature-resistant metal alloy, in particular made of high-grade steel or a nickel-based alloy. In the cover 62, a thermally conductive and electrically insulating material 64 is partially provided. In the present exemplary embodiment, this thermally conductive and electrically insulating material 64 is magnesium oxide. In the thermally conductive and electrically insulating material 64, an electrical conductor 66 is embedded. This electrical conductor 66 has a dissipation which is increased in comparison with an electrical supply line to the braking resistance element 20. In this manner, in the longitudinal extent direction 30 of the tubular heating member and consequently of the braking resistance element 20, a dissipation path 42 is produced. Along the dissipation path 42, electrical energy can be converted into thermal energy. By means of the material 64 mentioned, it is possible to store high quantities of thermal energy which occur briefly and subsequently to discharge them into the environment. This enables the stack arrangement 14 to nonetheless be cooled despite, particularly briefly occurring, high quantities of thermal energy simply using the airstream 38. In the present exemplary embodiment, each dissipation path 42 of the dissipation paths 42 has a coherent length of at least six meters.

The braking resistance elements 20 of the stack arrangement are arranged to be spaced apart from each other in such a manner that a travel wind can flow through the stack arrangement 14. In this instance, the travel wind can flow from an uppermost layer 22 of the stack arrangement 14 to a lowest layer 24 of the stack arrangement 14. In this manner, the travel wind can flow around and cool all the braking resistance elements 20 of the four layers 18. An electrical energy which is converted at the braking resistance elements 20 can thus be discharged with the travel wind as thermal energy. So that in this instance the smallest possible flow resistance is achieved, a clear spacing 26 between directly adjacent braking resistance elements 20 of each of the four layers 18 has 1.5 times the value of the pipe diameter of the braking resistance elements 20. In addition, another clear spacing 28 between the braking resistance elements 20 of a layer of the four layers 18 with respect to braking resistance elements 20, which are arranged directly adjacent to these braking resistance elements 20, of a layer of the four layers 18 which is arranged directly adjacent to this layer is at least 0.5 times the value of the pipe diameter of the braking resistance elements 20. In this manner, the clear spacing 26 between braking resistance elements 20, which are arranged directly adjacent, of one of the four layers 18 is three times as large as the other clear spacing 28 between the braking resistance elements 20 of one of the four layers and the braking resistance elements 20 of another layer of the four layers 18 which is arranged directly adjacent to this layer.

In order to space the braking resistance elements 20 apart from each other as described above, in the present exemplary embodiment floating bearings 32 are provided. These floating bearings 32 may each have a plurality of floating bearing retention flaps 58, which are secured to a floating bearing carrier portion 60. The floating bearing retention flaps 58 are configured to permit a sliding movement of the braking resistance elements 20 along a longitudinal extent direction 30 of the braking resistance elements 20 relative to the floating bearing retention flaps 58. Furthermore, there are provided insulation plates which are not illustrated in greater detail and by means of which a thermal conduction from the braking resistance elements 20 through the floating bearings 32 into a load-bearing structure is prevented.

FIG. 3 shows an embodiment of the above-described floating bearing 32 having impact faces 34 which are in the form of flow lines in a schematic illustration. In this instance, a cut-out of the stack arrangement 14 is shown. Both impact faces 34 of the floating bearing retention flaps 58 and impact faces 34 of the floating bearing carrier operation 60 are constructed in a chamfered manner. Preferably, a length of a chamfered face of the floating bearing carrier portion 60, when measured in a plane substantially perpendicular to the stack direction 16, has approximately 4.5 times the thickness of the floating bearing carrier portion 60, when measured in this plane. In addition, the impact faces 34 are constructed to be partially round. A flow resistance of the floating bearing 32 can be minimized in this manner.

FIG. 4 shows in a schematic illustration a cut-out of the braking resistance apparatus 10 shown in FIG. 1 in a plane substantially perpendicular to the stack direction 16 and the longitudinal extent direction 30 of the braking resistance elements 20. The position of the portion of the braking resistance apparatus 10 as shown in FIG. 4 is denoted in FIG. 1 with the Roman numeral “IV” and corresponds to one of two mutually opposing end regions of the braking resistance apparatus 10. These opposing end regions which have been mentioned correspond in a mirror-symmetrical manner. For the sake of clarity, only one of the two end regions mentioned is shown in a manner representative of both end regions.

The stack arrangement 14 is in the present exemplary embodiment arranged in a housing 52. The housing 52 is constructed in a vessel-like manner and has an opening at an upper side. The opening extends in the longitudinal extent direction 30 of the braking resistance elements 20 over an entire length of the dissipation paths 42 of the braking resistance elements 20. In the present exemplary embodiment, the housing 52, as also shown in FIG. 1, is constructed integrally with the recess 56 of the vehicle shell 54. In the present exemplary embodiment, a maximum stack height of the stack arrangement 14 is smaller than a maximum housing height of the housing 52. In this manner, the braking resistance apparatus 10 can be arranged in a state recessed in the recess 56 in such a manner that the uppermost layer 22 of the four layers 18 is arranged below a vehicle shell 54 which surrounds the recess 56.

Furthermore, in the present exemplary embodiment, the housing 52 and consequently the recess 56 is delimited at two sides by a fluid-guiding element 36 in each case. The fluid-guiding elements 36 are configured, in order to cool the braking resistance elements 20 which are arranged in multiple layers, to introduce the airstream 38 into the stack arrangement 14 and to discharge the airstream 38 from the stack arrangement 14. The two fluid-guiding elements 36 are in each case arranged in one of the above-mentioned end regions of the braking resistance apparatus 10. Each of the two fluid-guiding elements 36 is partially in the form of a ramp. This ramp has an oblique plane which in the present exemplary embodiment is inclined at an angle 40 of substantially 21° with respect to the longitudinal extent direction 30 of the braking resistance elements 20. Furthermore, the fluid-guiding elements 36 have in the transition regions thereof to the vehicle shell 54 in each case round portions. This round portion protrudes in the present exemplary embodiment over a height of a directly adjacent region of the vehicle shell 54. In this manner, the braking resistance elements 20 which are arranged one above the other in multiple layers in the stack arrangement 14 may be passively cooled by means of the airstream 38 with little flow resistance.

The braking resistance elements 20 of the stack arrangement 14 extend in each case through the two fluid-guiding elements 36. The dissipation paths 42 of the braking resistance elements 20 in contrast are exclusively arranged in a region, through which the airstream 38 flows, of the housing 52 and terminate in each case in front of a front side 44, which is subjected to a flow of the travel wind, of the fluid-guiding elements 36. In this manner, the dissipation paths 42 of the braking resistance elements 20 are exclusively arranged within the housing 52 in a space which is delimited by the front sides 44, which are subjected to the flow by the travel wind, of the two fluid-guiding elements 36. The dissipation paths 42 of the braking resistance elements 20 of the uppermost layer 22 are longer than the dissipation paths 42 of the braking resistance elements 20 of the layers 18 which are arranged below the uppermost layer 22. In addition, there are embedded in the braking resistance elements 20 of the uppermost layer 22 electrical conductors 66 which in comparison with electrical conductors 66 which are embedded in one of the remaining braking resistance elements 20 of the remaining layers of the plurality of layers 18 converts a larger quantity of electrical energy into thermal energy. A better thermal discharge as a result of the airstream 38 at the uppermost layer 22 in comparison with remaining layers of the plurality of layers 18 thus leads to a variation of a temperature within the stack arrangement 14 being reduced. In the present exemplary embodiment, the dissipation paths 42 of the braking resistance elements 20 of the lowest layer 24 in comparison with the dissipation paths 42 of the braking resistance elements 20 of the remaining layers are the shortest dissipation paths 42. The dissipation paths 42 are in this instance adapted to the partially ramp-like extent of the two fluid-guiding elements 36.

Furthermore, in the present exemplary embodiment, there are provided partition walls 50 by means of which an electrical connection region 48 of the braking resistance elements 20 can be thermally shielded. Between the electrical connection region 48 and a rear side 46 of each of the two fluid-guiding elements 36, two partition walls 50 are arranged. The two partition walls 50 have different inclinations with respect to the longitudinal extent direction 30 of the braking resistance elements 20. In this manner, it is possible in a simple manner to prevent large portions of a thermally charged airstream 38 from reaching the electrical connection region 48 of the braking resistance elements 20.

Although the invention has been illustrated and described in greater detail by the preferred exemplary embodiments, the invention is not limited by the disclosed examples and other variations can be derived therefrom by the person skilled in the art without departing from the protective scope of the invention.

1-14. (canceled)

15. A braking resistance apparatus for a vehicle, the braking resistance apparatus comprising:
a plurality of braking resistance elements each having:
a tubular, thermally conductive cover;
a thermally conductive and electrically insulating material disposed in said cover; and
an electrical conductor embedded in said thermally conductive and electrically insulating material and extending over a large portion of a longitudinal extent of said cover;
said plurality of braking resistance elements being arranged in a stack arrangement with a plurality of layers;
each of said plurality of layers being formed of a plurality of braking resistance elements that are arranged substantially parallel with one another; and
said stack arrangement of said braking resistance elements being configured to be passively cooled.

16. The braking resistance apparatus according to claim 15, wherein said braking resistance elements of said stack arrangement are spaced apart from one another to allow an airstream due to a movement of the vehicle to flow through said stack arrangement, with the airstream flowing from an uppermost layer of said stack arrangement to a lowermost layer of said stack arrangement.

17. The braking resistance apparatus according to claim 15, wherein:
each of said plurality of layers is formed with said braking resistance elements arranged substantially parallel with each other in a plane that extends substantially perpendicularly to a stacking direction; and
a clear spacing between directly adjacent said braking resistance elements of a first layer of said multiple layers is at least twice as large as a clear spacing between said braking resistance elements of said first layer and said braking resistance elements of another, directly adjacent layer of said plurality of layers.

18. The braking resistance apparatus according to claim 17, wherein the clear spacing between the directly adjacent said braking resistance elements of said first layer is at least three times greater than the other clear spacing between the braking resistance elements of said first layer and said braking resistance elements of the other layer of the plurality of layers which is arranged directly adjacent said first layer.

19. The braking resistance apparatus according to claim 17, wherein the clear spacing between directly adjacent braking resistance elements of a layer of said plurality of layers has at least 1.5 times a value of a greatest extent of one of said braking resistance elements which are arranged directly adjacent, when measured in a plane substantially perpendicular to a longitudinal extent direction of said braking resistance element.

20. The braking resistance apparatus according to claim 15, further comprising floating bearings disposed to support and space said braking resistance elements of said stack arrangement apart from one another, said floating bearings having impact faces with a flowline shape.

21. The braking resistance apparatus according to claim 15, further comprising at least one fluid-guiding element disposed to direct an airstream due to a movement of the vehicle into said stack arrangement in order to cool said braking resistance elements that are arranged in multiple layers.

22. The braking resistance apparatus according to claim 21, wherein:
said at least one fluid-guiding element is, at least in part, formed as a ramp;
said ramp is, at least in part, formed as an oblique plane; and
said oblique plane is inclined with respect to a longitudinal extent direction of said braking resistance elements of said stack arrangement by an angle having a value between 10° and 25°, inclusive.

23. The braking resistance apparatus according to claim 22, wherein said angle lies in a value range of from 19° to 23°.

24. The braking resistance apparatus according to claim 22, wherein said angle enclosed between said ramp and said braking resistance elements is substantially 21°.

25. The braking resistance apparatus according to claim 21, wherein:
said braking resistance elements of said stack arrangement extend through said at least one fluid-guiding element; and
said braking resistance elements of said stack arrangement have dissipation paths arranged in a space formed on one side that is delimited by a front side of said at least one fluid-guiding element that is subjected to an airstream due to a movement of the vehicle.

26. The braking resistance apparatus according to claim 25, further comprising:
at least one partition wall disposed between a rear side of said fluid-guiding element opposite the front side thereof and an electrical connection region of said braking resistance elements; and
said at least one partition wall being formed to thermally shield the electrical connection region of said braking resistance elements.

27. The braking resistance apparatus according to claim 25, wherein said dissipation paths of said braking resistance elements of a first layer of said plurality of layers and said dissipation paths of said braking resistance elements of another layer of said plurality of layers are constructed with mutually different lengths.

28. The braking resistance apparatus according to claim 25, further comprising:
a housing containing said stack arrangement, said housing having an opening on one side thereof that extends over at least 80% of a length of one of said dissipation paths of said braking resistance elements of said stack arrangement; and
wherein a maximum stack height of said stack arrangement is less than or equal to a maximum housing height of said housing.

29. The braking resistance apparatus according to claim 28, wherein said housing is a vessel-shaped housing and said opening extends over an entire length of a longest dissipation path of said dissipation paths of said braking resistance elements.

30. The braking resistance apparatus according to claim 28, wherein said dissipation paths of said braking resistance elements of said stack arrangement are arranged exclusively inside said housing.

31. A vehicle, comprising:
a vehicle shell formed with a recess; and
a braking resistance apparatus according to claim 15 recessed in said recess of said vehicle shell;
said braking resistance apparatus having an uppermost layer of the plurality of layers of the stack arrangement arranged level with, or below, said vehicle shell that surrounds said recess.

32. A method, comprising:
providing the braking resistance apparatus according to claim 15 in a vehicle; and
operating the braking resistance apparatus during a travel of the vehicle and cooling the braking resistance elements that are arranged one above another in multiple layers in a stack arrangement by an airstream flow caused by a movement of the vehicle.
